(19) United States
(12) Patent Application Publication
(10) Pub. No.: US 2010/0154413 A1
(43) Pub. Date: Jun. 24, 2010

(54) GAS-DYNAMIC PRESSURE WAVE MACHINE

(75) Inventors: Georg Glitz, Paderborn (DE); Urs Wenger, Burgdorf (CH); Christian Smatloch, Paderborn (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: BENTELER AUTOMOBILTECHNIK GMBH, PADERBORN (DE)

(21) Appl. No.: 12/377,057

(22) PCT Filed: Apr. 23, 2008
(86) PCT No.: PCT/DE08/00693

§ 371 Date: Feb. 10, 2009

(30) Foreign Application Priority Data
May 4, 2007 (DE) 10 2007 021 367.2

(51) Int. Cl. F02B 33/42

(52) U.S. Cl. 60/605.1

(57) ABSTRACT

The invention relates to a gas-dynamic pressure wave machine for charging an internal combustion engine comprising a cell rotor (1) rotatably supported in a housing and located between an inlet for charge air and an exhaust line for combustion gases, wherein the outer circumference of the cell rotor (1) increases from the exhaust gas side (3) to the charge air side (4). The height of a cell of the cell rotor (1) in the radial direction remains constant in the longitudinal direction of the cell rotor (1), while the cross-sectional area of the individual cells increases from the exhaust gas side to the charge air side.

The invention relates to a gas-dynamic pressure wave machine for charging an internal combustion engine according to the features recited in the preamble of claim 1.

Internal combustion engines for motor vehicles are charged to increase their efficiency, i.e., their volumetric efficiency is improved. With a smaller displacement, charged engines have a smaller specific consumption than non-supercharged engines with the same power rating.

Charging systems which produce gas-dynamic processes in closed gas channels and use these processes for charging, are generally referred to as pressure-wave chargers or gas-dynamic pressure wave machines. The cell rotors employed with gas-dynamic pressure wave machines are typically manufactured from cast material. The cell rotors are cylindrical and have channels that typically extend with a constant cross-section in the axial direction from the hot-gas side to the cold-gas side. It is known to actively drive the rotor of pressure-wave chargers that operate as charge air compressors for internal combustion engines. EP 0 235 609 A1 discloses as conventional a freewheeling pressure-wave charger which is a driven by the gas forces. The cell rotor has cell partition walls which are parallel or inclined with respect to the rotor axis or have a helical configuration. The cell rotor is driven by exposing the cell partition walls to high-pressure exhaust gases which reach the rotor housing through gas channels with a corresponding entrance angle, and cause rotation of the cell rotor as a result of the inflowing exhaust gas.

DD 285 397 A5 discloses a gas-dynamic pressure wave machine having a non-constant cell cross-section. The changing cross-section is intended to improve the most important gas-dynamic parameters compared to those of cylindrical rotors. A change of the radial cell height with the rotor length x by an amount 2ax^{b} with a=0.03 to 0.1 and b=1.5 to 2.5 is intended to improve the results.

DE 690 08 541 T2 discloses a pressure exchanger with a rotor shaped as a truncated cone. The radial height of the individual rotor cells varies in the longitudinal direction of the rotor. EP 0 431 433 A1 discloses a pressure exchanger for an internal combustion engine, wherein the pressure exchanger is described as having an increased scavenging energy. The individual cells of the cell rotor typically have a constant cross-section along their longitudinal axes, which due to the inclination of the cells with respect to the longitudinal axis is possible only with a decreasing cell height.

Conventional aerodynamic pressure wave machines employing cylindrical rotors are also disclosed in DE 1 428 029 B. The individual cells can be connected with a cover band and a hub, either mechanically, by welding or by soldering. The cells can also be manufactured from box profiles or a meander-shaped, curved band. GB 1 058 577 A discloses a design with several concentric cell rings. Several cell geometries have been proposed. GB 920 624 A proposes to construct the cell partition walls from sheet metal bent into a Z-shape. The individual cells can also have a honeycomb structure, as disclosed in GB 840 408 A. GB 920 908 discloses an arrangement of cells having several concentric rings, whereby the cell cross sections may differ from ring to ring.

To improve the catalytic effects for the exhaust gases in internal combustion engines charged with pressure wave machines, EP 0 143 956 A1 proposes to coat the cells of the cell wheel with a catalytic material.

The collective thermal load to which the entire cell rotor assembly is subjected represents a problem for conventional systems. For example, temperatures on the hot-gas side of the cell rotor may reach 1100° C., whereas the maximum temperature on the cold-gas side is 200° C. This causes a thermally induced distortion of the components and consequently sub-optimal efficiency. The dimensional stability of the gap between the gas-conducting elements causes particular problems.

The gas entrance angles for uniform gas channels extending straight in the axial direction are not optimized. Cast cell rotors also have a high moment of inertia due to the considerable wall thickness. The fabrication of fine cell structures by casting is also quite expensive. Casting also requires relatively expensive control methods and has high reject rates.

Due to the difficult manufacture and the required profiles of the pressure wave charger, an economical manufacture of a cell rotor on an industrial scale is quite problematic when taking into consideration all requirements.

It is therefore an object of the invention to optimize the manufacture of a gas-dynamic pressure wave machine for charging an internal combustion engine, in particular with respect to the design of the cell rotor, and to increase the efficiency of the pressure wave machine.

The object is attained by a gas-dynamic pressure wave machine having the features of claim 1.

Advantageous embodiments of the invention are recited in the dependent claims.

According to the core concept of the invention, the outer circumference of the cell rotor increases from its exhaust gas side to the charge air side. The resulting non-cylindrical configuration of the cell rotor makes it possible to cost-effectively manufacture assembled, i.e. not cast, cell rotors with a high manufacturing accuracy. The reason is that tight dimensional tolerances, in particular narrow joining gaps, can be maintained between adjacent cells when the individual cell partition walls are connected with the casing elements which delimit the cells radially inwardly and outwardly, i.e., on the outside with an outer casing and on the inside with an inner casing. Due to the non-cylindrical outer contour of the cell rotor, a previously produced outer casing can be pushed over the individual cell partition walls, wherein the joining gap is minimized by shifting the outer casing or the inner casing in the longitudinal direction of the cell rotor, which can produce a cost-effective, reliable and very precise connection between the individual components, in particular by soldering or fusion-welding. The casing elements of the cell rotor can be somewhat longer than the individual cell partition walls, so that a relative displacement in the direction of the common longitudinal axis can produce the smallest possible joining gap.

The non-cylindrical outside contour of the cell rotor also enables self-centering of the casing elements during the joining process. When constructing cylindrical cell rotors, then significantly tighter tolerance ranges would need to be maintained in order to attain joining gaps which are uniformly small around the circumference.

The cell rotor is preferably in the form of a truncated cone. This attribute relates to its outer geometry. The form of the outer geometry also determines the inner geometry of the cell rotor, because the height of a cell, as measured in the radial direction, should remain constant over the longitudinal extent of the cell rotor. The cross-sectional area of the individual cells nevertheless increases from the exhaust gas side to the charge air side, because the annular area of a cell ring also increases from the charge gas side to the exhaust gas side while, however, the number of cells remains constant. The increase in the cross-sectional area towards the exhaust gas side reduces the velocity of the combustion gas within a cell and hence causes a pressure increase, so that the efficiency and the degree of pressure charging attained with the pressure wave machine can be increased.

The advantages of the invention are not only attained with cell rotors in the shape of a truncated cone, but also when the outer casing of the cell rotor is curved in the longitudinal direction of the cell rotor, so that consequently all cells are curved in the longitudinal direction, meaning that the cells have on the cold gas side a greater distance to the rotation axis of the cell rotor than on the hot gas side exposed to the exhaust gas. The curvature can be constant over the length of the cell rotor. Preferably, the curvature of the outer casing increases from the exhaust gas side to the charge air side. The casing can therefore have a parabolic curvature in the longitudinal direction of the cell rotor, or can form a parabolic rotating body. It is also theoretically feasible to arrange straight or curved curve sections, i.e., those with constant and variable slope, sequentially so that the outer circumference of the cell rotor increases from the exhaust gas side to the charge air side. In any event, the height of the cells should remain constant.

In a practical application, the angle between the rotation axis or the longitudinal axis of the cell rotor and its outer casing can reach 50°. The angle can vary depending on the curvature or slope of the outer casing. Preferably, the angle is greater than 20°.

The cell rotor can be assembled from semi-finished parts made of different materials. In other words, in particular metallic materials, in particular steels of different chemical composition with different mechanical properties, can be employed. For example, the individual cells can be formed of thin sheet metal elements. The gas guiding lattice formed of the cell partition walls can be fabricated from curved, thin sheet metal elements and connected with the outer and inner supporting structural elements, i.e., an outer casing and an inner casing. The finely structured cell partition walls are preferably made of a thin stainless steel sheet with wall thicknesses in a range from 0.05-1.0 mm.

The casing can be produced by conically widening a cylindrical tubular component, i.e., by cold working. By selecting materials suitable for the application, both the weight and the mass of inertia can be significantly reduced compared to cast components. At the same time, the blocking surfaces and blind surfaces caused by the individual cell partition walls can be significantly reduced, whereby an optimum structure is desired which has as many cells as possible with the smallest blind or blocking surface area. The optimum ratio of the cross-sectional areas of the cells to the cross-sectional area of the individual cell partition walls is essentially material-dependent, because the individual cell partition walls are exposed to severe mechanical and thermal stress.

Because semi-finished parts with a very small wall thickness are used for the cell partition walls, the structure of the cell rotor according to the invention is closed along the circumference. Depending on the size of the rotor, 1 to 3 concentric cell rings are provided which are separated from one another by concentric casing elements. When several cell rings are employed, the casing element separating the cell rings is simultaneously the outer casing for the inner cell ring and the inner casing for the outer cell ring.

Another important aspect of the invention is the reduced noise generation of the pressure wave machine. A cell rotor has typically identically sized cell cross sections about its entire circumference. This poses the risk that standing waves are produced inside the cell rotor of internal combustion engines, which causes noise generation due to the excitation of resonance oscillations. With the cell rotor of the invention, pressure wave machines can be constructed which are tuned to the respective internal combustion engine, by arranging mutually different cells irregularly about the circumference of the cell rotor in the circumferential direction. In other words, noise generation can be extremely limited or even prevented by varying the spacing between the individual cell partition walls. By varying the spacing, the plurality of individual cells chops up the acoustic pressure wave from the exhaust gas tract of the internal combustion engine, so that a constant exhaust gas flow is produced at the output of the cell wheel, which has only small pressure variation and hence minimum sound emission. Unlike with cell rotors produced by casting, resonance oscillations can be easily and cost-effectively limited or prevented already during the manufacture by changing the position of individual cell partition walls.

The cells are arranged along the circumference with an irregular arrangement of consecutive cells differing in widths and/or lengths. In the simplest case, two cells having different widths are distributed non-uniformly, i.e., with an intentionally irregular pattern, about the circumference of the cell rotor so as to avoid repetition and thus potential excitation of resonance oscillations. The irregular distribution of the cells along the circumference does not relate to a single cell ring, but to the cells of all cell rings. Advantageously, the relative deviations in the circumferential spacing between the cells of a particular cell ring may be identical. If the cells of a cell ring extend, for example, in one case over 2° and in another case over 3.5°, then this ratio applies also to the cells of additional cell rings. Preferably, the cells form ring segments in cross-section.

The cell rotor according to the invention may include balance rings which are preferably mounted on both ends of the cell wheel. The balance rings are used to support the filigree cell system and also provide a sealing function to the adjacent exhaust gas lines and charge air lines, respectively. The outer casing can be additionally affixed via the balance rings. The balance rings are also used to compensate for non-uniform mass distributions.

Advantageously, the surface of the cell partition walls may be intentionally roughened to minimize gas friction on the cell partition walls. This roughened surface structure minimizes the boundary layer in the fluid and improves the flow conditions inside the individual cells. This feature of the roughened surface structure can also be relatively easily and cost-effectively implemented with assembled cell wheels, unlike with cast parts.

In addition, a catalytic coating can be applied at least partially to the cell partition walls, which causes additional exhaust gas cleaning processes already while the exhaust gas is charged.

A rotation of the cell rotor of the invention for the entrance angle of the gas flow can be caused by orienting the cell walls at an angle to the rotation direction. The cell walls may be aligned parallel to or inclined to the rotor axis.

With the pressure wave machine of the invention, the overall length of the cell rotor can advantageously be shortened while keeping the length of the gas channels or of the individual cells constant. This effect is the more pronounced the greater the angle between the longitudinal center axis of the cell rotor and the outer casing.

Improved manufacturability of the cell rotor represents a significant advantage of the invention. The cell partition walls which are connected with the outer casing and/or the inner casing by a material connection and/or form-fittingly, can be joined with high precision. For example, the cell system may be mechanically connected with the adjacent casing elements. Most advantageous are soldering processes. Any dimensional deviation can be significantly reduced by a non-cylindrical structure, in particular by a conical shape of the components. In addition, readjustment is possible based on self-centering of individual components of the pressure waves of the cell rotor; likewise, process changes during the manufacture of the cell rotor as well as changes in the geometry can be implemented with great flexibility and in a very short time.

The supporting inner system of the cell rotor can be manufactured by metal cutting. This refers to a shaft with corresponding bearing means, on which corresponding sealing means are provided.

Basically, the individual components of the cell rotor can be produced using production methods such as bending, deep-drawing or hydro-forming, wherein the choice of the manufacturing methods depends extensively on the geometry of the components. Accordingly, many possibilities exist for creating the cells. In a particularly advantageous embodiment, the cell partition walls are alternatingly connected with one another in the region of the outer casing and in the region the inner casing, thereby becoming part of a meander-shaped cell sheet metal extending in the circumferential direction of the cell rotor. Such cell sheet metal is transformed to the desired non-cylindrical shape during installation due to the small wall thicknesses, in particular a conical shape, and joined to the outer casing and the inner casing.

Alternatively, individual cell partition walls can be installed, in particular those having a Z-shaped cross-section. The respective upper and lower leg of a Z-shaped cell partition wall is used for joining with the outer casing and the inner casing, respectively.

Also feasible are double-Z-shaped cell partition walls, wherein the average cross-section of cell partition walls structured in this way form a sort of casing which extends between the radially outermost and the radially innermost region of the cell partition walls or the cells, respectively, and thereby forms quasi a lateral separation surface.

The cell partition walls may also be part of cell elements with a U-shaped cross-sectional profile, i.e., in general part of open hollow profiles. Alternatively, the cell partition walls may also be part of thin-walled, closed hollow profiles. For example, a number of spaced-apart rectangular profiles may be distributed along the circumference.

Varying the spacing between the individual rectangular profiles results in the desired variation of the cross sections of the individual cells.

A schematic exemplary embodiment of the invention will now be described with reference to the drawings.

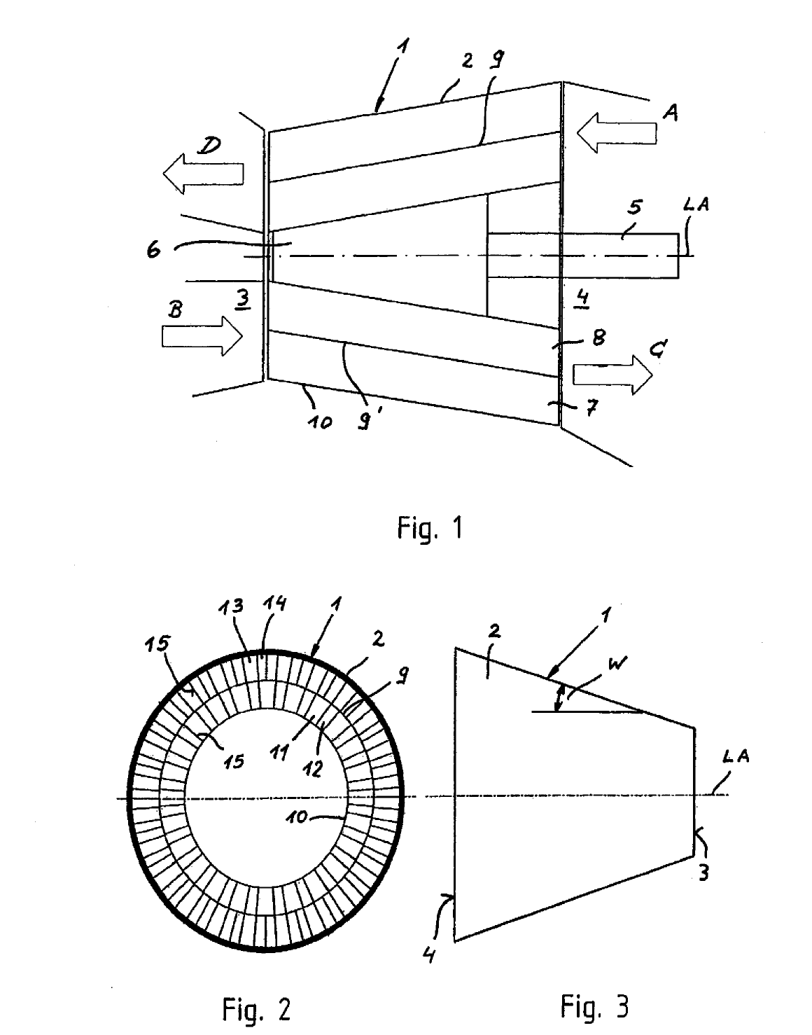

FIG. 1 shows a longitudinal cross-section through the rotor of a pressure wave machine, and

FIGS. 2 and 3 are a front view and a side view of a schematic diagram of a cell rotor.

FIG. 1 shows a cell rotor 1 which forms the core component of a gas-dynamic pressure wave machine for charging an internal combustion engine. The cell rotor 1 is supported in a housing (not shown in detail) for rotation about its longitudinal axes LA. The cell rotor 1 is arranged between a supply line for charge air and an exhaust gas line for combustion gases. The arrow A indicates the inflow direction of the charge air. The air received inside the cell rotor 1 is compressed by the inflowing exhaust gases which flow into the cell rotor 1 from the opposite side in the direction of arrow B. The compressed intake air is expelled in the direction of arrow C. The exhaust gas exits from the cell rotor 1 in the direction of arrow D.

The non-cylindrical structure of the cell rotor is essential for the invention. The cell rotor 1 has an outer casing 2 which is circumferentially closed and has in the illustrated exemplary embodiment the shape of an envelope of a cone. The overall cell rotor has therefore the shape of a truncated cone. The outer circumference of the cell rotor increases from the exhaust gas side 3 to its charge air side 4. The cell rotor is supported on a shaft 5 which may be coupled with drive means (not shown). The shaft 5 has a hub 6 formed as a truncated cone, to which a cell structure of the cell rotor 1 is attached. The gas-permeable regions of the cell rotor 1 are arranged in two concentric cell rings 7, 8. The cell rings 7, 8 are each closed in the radial direction, so that gas exchange can occur only in the longitudinal direction of the cell rotor 1. The height of the individual cells measured in the radial direction is constant. This means that the outer casing 2 is parallel to an inner casing 9 of the outer cell ring. This inner casing 9 can be viewed in relation to the innermost cell ring as outer casing 9′ which in conjunction with another, radially inner casing 10 delimits the radially innermost cell ring 8 in the radial direction. All casing elements 2, 9, 10 are arranged concentric with respect to one another.

As illustrated in FIG. 2, the cell rotor 1 has a plurality of cells 11, 12, 13, 14. Cell partition walls 15 formed of sheet metal elements are arranged between the individual cells 11-14. The cell partition walls 11-15 are preferably connected with the corresponding inner casing 9, 10 and/or the corresponding outer casing 2, 9′ by a material connection, for example by soldering or fusion-welding.

Each cell ring 7, 8 has two cells with different dimensions along the circumference. Preferably, the respective cell types 11, 12; 13, 14 are uniformly distributed about the circumference of the cell rotor 1.

The side view of FIG. 3 illustrates in addition the angle W, as measured between the outer casing 2 and the longitudinal axis LA of the cell rotor 1. The angle W is maximally 50°.

### LIST OF REFERENCE SYMBOLS

1 cell rotor
2 outer casing
3 exhaust gas side
4 charge air side
5 shaft
6 hub
7 cell ring
8 cell ring
7 inner casing
9′ outer casing
10 inner casing
11 cell
12 cell
13 cell
14 cell
15 cell wall
LA longitudinal axis
A arrow
B arrow
C arrow
D arrow
W angle

1.-19. (canceled)

20. A gas-dynamic pressure wave machine for charging an internal combustion engine, comprising:
a housing; and
a cell rotor rotatably supported in the housing between a charge air side and an gas side and having a plurality of cells, said cell rotor having an outer circumference which increases from the exhaust gas side to the charge air side, wherein a height of a cell measured in a radial direction remains constant in a longitudinal direction of the cell rotor, while a cross-sectional area of the cell increases from the exhaust gas side to the charge air side.

21. The gas-dynamic pressure wave machine of claim 20, wherein the cell rotor is shaped as a truncated cone.

22. The gas-dynamic pressure wave machine of claim 20, wherein the cell rotor comprises an outer casing having a curvature in the longitudinal direction of the cell rotor.

23. The gas-dynamic pressure wave machine of claim 22, wherein the curvature of the outer casing increases from the exhaust gas side to the charge air side.

24. The gas-dynamic pressure wave machine of claim 23, wherein the curvature of the outer casing is parabolic.

25. The gas-dynamic pressure wave machine of claim 20, wherein the cell rotor comprises a plurality of semi-finished parts made of different materials.

26. The gas-dynamic pressure wave machine of claim 20, wherein the cell rotor includes cell partition walls which extend from the exhaust gas side to the charge air side, said cell partition walls being made of sheet metal elements which are connected with an inner casing and an outer casing.

27. The gas-dynamic pressure wave machine of claim 26, wherein the cell partition walls have a wall thickness from 0.05 to 1.0 mm.

28. The gas-dynamic pressure wave machine of claim 26, wherein the cell partition walls are materially connected with the inner casing or the outer casing, or both, by soldering or welding.

29. The gas-dynamic pressure wave machine of claim 26, wherein the cell partition walls are form-fittingly connected with the inner casing or the outer casing, or both.

30. The gas-dynamic pressure wave machine of claim 26, wherein the cell partition walls are connected alternatingly with one another in a region of the outer casing and in the region of the inner casing, thereby forming a meander-shaped cell metal sheet extending in a circumferential direction of the cell rotor.

31. The gas-dynamic pressure wave machine of claim 26, wherein the cell partition walls have in cross-section a double-Z-shaped configuration.

32. The gas-dynamic pressure wave machine of claim 20, further comprising one, two or three concentric cell rings, wherein adjacent cell rings are separated from one another by a concentric casing element.

33. The gas-dynamic pressure wave machine of claim 20, wherein cells having different circumferential dimensions are irregularly distributed along a circumference of the cell rotor.

34. The gas-dynamic pressure wave machine of claim 32, wherein within a particular cell ring, the cells have identical relative deviations in a circumferential direction.

35. The gas-dynamic pressure wave machine of claim 20, wherein the cells form ring segments when viewed in cross-section.

36. The gas-dynamic pressure wave machine of the claim 20, further comprising at least one balancing ring disposed on an outer circumference of the cell rotor.

37. The gas-dynamic pressure wave machine of claim 26, wherein the cell partition walls have at least partially a roughened surface structure.

38. The gas-dynamic pressure wave machine of claim 26, wherein the cell partition walls comprise at least partially a catalytic coating.
